(19) United States
(12) Patent Application Publication
(10) Pub. No.: US 2026/0017970 A1
(43) Pub. Date: Jan. 15, 2026

(54) IMAGE ANALYSIS USING A MULTIMODAL LARGE LANGUAGE MODEL

(71) Applicant: CrowdStrike, Inc., Sunnyvale, CA (US)

(72) Inventors: Andrew Southgate, Cambridge (GB); Calin-Bogdan Miron, Nottingham (GB); Dragos Georgian Corlatescu, Bucharest (RO); Paul Sumedrea, Bucharest (RO)

(21) Appl. No.: 18/773,123

(22) Filed: Jul. 15, 2024

(51) Int. Cl. G06V 30/262; G06F 40/40; G06V 30/42; H04L 9/40

(52) U.S. Cl. CPC G06V 30/274; G06F 40/40; G06V 30/42; H04L 63/1416

(57) ABSTRACT

Techniques for automatically determining semantic information for images associated with a data stream using a multimodal large language model (m-LLM) are discussed herein. For example, a system can implement the m-LLM to receive image data as input and output human-readable descriptions for portions of the image data. The techniques can include receiving input data from a variety of different data sources, and interpreting a meaning of the data regardless of an operating system, data format, or other data type associated with the input data.

### BACKGROUND

With computer and Internet use forming an ever greater part of day to day life, security exploits and cyberattacks directed to stealing and destroying computer resources, data, and private information are becoming an increasing problem. Some attacks are carried out using “malware”, or malicious software. “Malware” refers to a variety of forms of hostile or intrusive computer programs that, e.g., disrupt computer operations or access sensitive information stored on a computer (e.g., viruses, worms, Trojan horses, ransomware, rootkits, keyloggers, spyware, adware, or rogue security software). Malware is increasingly obfuscated or otherwise disguised in an effort to avoid detection by security software. Determining whether a program is malware or is exhibiting malicious behavior can thus be very time-consuming and resource-intensive.

Typically a user analyzes a data transaction or image to classify portions of the data transaction or the image as originating from a threat actor (e.g., Yes) or not (e.g., No). Before the portions of the data transaction of the image can be classified as originating from the threat actor, the user provides input to the computer to define the portions of the data transaction of the image that represent a security threat. Thus, the security threat can be undetected for a period of time until the user analyzes and defines the data transaction or the image thereby impacting operation of the computer.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example block diagram of an example computer architecture for determining semantic information for example input data, as described herein.

FIG. 2 is a pictorial diagram illustrating an example process to determine descriptions for example image data by an example computing device, as described herein.

FIG. 3 is a pictorial diagram illustrating another example process for determining descriptions for example graphs and optionally providing the descriptions to a storage device and/or a computing device, as described herein.

FIG. 4 is a flowchart depicting an example process for determining semantic information and/or a context for image data.

FIG. 5 is a block diagram of an illustrative computing architecture to implement the techniques describe herein.

### DETAILED DESCRIPTION

This application describes techniques for automatically determining semantic information for images associated with a data stream using a multimodal large language model (m-LLM). For example, a system can implement the m-LLM to receive image data as input and output human-readable descriptions for portions of the image data. The techniques can include receiving input data from a variety of different data sources, and interpreting a meaning of the data regardless of an operating system, data format, or other data type associated with the input data. For example, the m-LLM can receive data from a computing device representing one or more of: a dashboard, a graph, metric data, log data, application data, etc. and determine descriptions (e.g., a function, a meaning, a context, a cause, an effect, etc.) for the input data. In some examples, the system can output the descriptions for display on a display device and/or in a user interface. Additionally, or alternatively, the system can employ a variety of interface types to enable a device and/or a user to navigate to a web page, a dashboard, a graph, etc. to change a size, resolution, etc. of an input image, upload a webpage, etc.

The system can provide descriptions usable to identify a malfunction, excessive load, unexpected inputs, accidental misconfiguration, hardware failures, or other failure or anomaly associated with the input data. A user (e.g., a software developer) can, in some examples, provide an input via a user interface indicating an image (or location thereof) for analysis by the system, and the system can output a description for an anomaly associated with the image. The system can also or instead implement the m-LLM to determine semantic information associated with potential security threats by a threat actor represented in the image, for example. By implementing the techniques described herein, the m-LLM can determine descriptions in less time and with more accuracy (versus not implementing the m-LLM) to improve detection of various anomalies including but not limited to a malfunction, an error, a security threat, etc.

In various examples, a system comprising a multimodal large language model (or other component or model) can determine a description for image data, audio data, and/or text data received as input. The system can output descriptions for the input regardless of the type of data input into the system. For example, the multimodal large language model can receive the input (e.g., a graph, a log, an identifier for a website, an image, etc.) from a host device, a third-party device, a storage device, and/or other data source regardless of the type of data format used by a respective device for monitoring, storage, or detection techniques. In some examples, the system can detect anomalies in the input data (e.g., between two graphs) and determine a cause or an effect of the respective anomalies in the input data.

In some examples, information output by the system can be used to train a machine learned model to detect security threats and/or to answer queries from a user of the host device (e.g., to understand security threats associated with an application). For example, the system can receive input data from an extended detection and response (XDR), a security information and event management (SIEM), or other security solution/technique and output data usable to answer a query about the input data (e.g., which portions of application data represent a potential malicious event). In various examples, the system can analyze visual data associated with a host device and generate output data describing a function and/or a meaning of the visual data. The output data can be transmitted to the host device based at least in part on receiving a query from the host device. In various examples, the visual data can represent a graph or other visual representation of data exchanges, transactions, activity, etc. by a host device being monitored for security threats.

In some examples, the system can determine descriptions for the visual data and optionally store the descriptions in a storage device for access by one or more computing devices (and developers). The stored data can be accessed at a later time by a computing device to define a security concept, generate security alerts, or the like. The security concept can represent a framework to identify presence or activity of a threat actor in the input data (e.g., a data string).

The system can, for example, receive image data associated with a webpage, dashboard, or user interface for processing and detect visual anomalies in the image data. Additionally, or alternatively, the system can provide descriptions for queries (from a customer device) related to the image data. For example, a computing device (or user thereof) can provide a URL to a particular dashboard or image, and the system can analyze the images associated with the URL over time to provide conclusions or descriptions about the images. For example, the system can access image data associated with the URL and respond to specific queries about the image data. In some examples, the system can periodically draw conclusions about the image data based at least in part on input from a device or user such as a time range, a portion of an image, and so on. The system can, for instance, generate alerts automatically over time based on analyzing of the image data.

In some examples, a service provider can employ the m-LLM to receive application data from a host device (e.g., a device receiving a security service from a service provider), and output descriptions for the application data (images, text, etc.). The descriptions of the application data can, for example, be used to answer a query, identify another service for the host device, etc. The techniques can include the m-LLM receiving graph data from the host device, detecting visual anomalies in one or more graphs, and generating semantic information indicating a function or a meaning of the graph(s). In various examples, the m-LLM can automatically generate text descriptions for responding to a customer query, for example, including identifying potential security threats in the input data independent of requiring separate models to process specific APIs, logs, or customer application types. By using the descriptions provided by the system as described herein, a same or different system can determine presence of potential security threats (e.g., an unauthorized process, thread, executable, or other activity) in the input data and/or in subsequent data received at a later time.

By using the techniques described herein, the system can automatically and proactively identify semantic information for various visual data independent of requiring user input to define the visual data. In some examples, the system can provide descriptions for application data, log data, graph data, and the like to a host device to improve analysis of data strings by the host device (e.g., to detect anomalous visual data such as malicious activity). The system can, for example, transmit descriptions for visual data associated with various devices over time so that the devices are capable of monitoring and analyzing subsequent data activity having similar visual data.

In some examples, the system can provide descriptions for input data responsive to receiving data for analysis from a host device, a third-party device, etc. For example, the host device can provide metric activity to the system by sending a link to a URL or other data source that includes visual data and text data (e.g., a label in a graph, an axis, etc.). The metric activity can represent an output rate, input rate, latency, a dashboard, or the like that is native to the host device, and the system can process data from a variety of devices regardless of naming system, schema, or format used by a respective device. In this way, the system can process the input data without requiring that the host devices conform to a common format resulting in faster responses to potential customer devices.

In various examples, the output data can, in some examples, be stored in a storage device as a “catalog” available to various devices. The stored description data can be updated, deleted, added, or otherwise managed over time to maintain a list of descriptions and associated with visual data that can be provided to the various devices periodically and/or upon request. In examples when an organization initiates a request for a security concept, the system can identify a related, existing security concept from the stored data, and send some or all of the stored data to the organization and/or to other organizations (e.g., and associated with host devices). In this way, descriptions can be provided to other devices in less time versus waiting for the system to perform the analysis for each security concept responsive to individual requests and can do so without requiring further input from an organization (e.g., from a developer or component of the host device to manually validate a description, write code, etc.).

In some examples, data output by the system can be transmitted to a host device to enable the host device to improve detection of visual data indicative of a security threat. Additionally, or alternatively, the data output by the system can be transmitted to a third-party device to recommend a security service available to the third-party device. By using the techniques described herein, the system can output the descriptions that enable improved detection, remediation, and analysis of data exchanged with various data sources (versus not implementing the system). In various examples, the system can be implemented as a cloud-based service configured to determine descriptions, security concepts, or the like, that improve operation of a computing device implementing an application, a service, or the like. The system can generate output data usable for subsequent detection of an anomaly, a malicious event (e.g., by improving how visual indicators of malicious activity are identified and mitigated), etc. The system can, for example, determine semantic information and/or a context for various types of input data usable for mitigating an error, malfunction, etc. caused by an anomaly in the input data. Data output by the system can represent semantic information and/or a context usable developing a defense strategy against future anomalies, malicious events, or the like.

In some examples, the system can implement a user interface to exchange data with one or more computing devices. The user interface can, for example, enable a user of a host device, third-party device, etc. to exchange data with the system (e.g., the m-LLM) including providing input data, submitting an inquiry about an image (e.g., an anomaly to look for, a problem experienced, or other data describing the input data), preferences for a security concept, etc. The user interface can also or instead be configured to receive data from the system for output on a display device (e.g., to present a description from the system). In various examples, the computing device(s) can receive description data as a service and independent of sending a request for such data. The user interface can, in various examples, include controls to receive the output data and modify a size of the image, or other setting, to further explore a cause or an effect of the anomaly and/or to generate new or updated descriptions, contexts, etc. For example, the user interface can receive a URL comprising image data, and the system can analyze data associated with the URL over time to describe anomalies in the image data. The user interface can also or instead receive queries about the image data and provide responses to the queries by rending the image data over time.

In various examples, the system can receive, as input data, a portion of the data stream from a storage device (or receive the portion in real-time independent of the database), such as a data stream database that receives (and in some instances replicates) all data associated with the data stream. By using the techniques described herein, data usable for protecting a host device and/or the data stream can be identified in less time and with more accuracy (e.g., versus relying on a human to analyze and convey the analyzed data to a user of the host device).

The system can employ a variety of different models to perform the techniques described herein. As described herein, models may be representative of machine learned models, statistical models, heuristic models, or a combination thereof. That is, a model may refer to a machine learning model that learns from a training data set to improve accuracy of an output (e.g., a prediction). Additionally or alternatively, a model may refer to a statistical model that is representative of logic and/or mathematical functions that generate approximations which are usable to make predictions.

The techniques described herein can improve the quality of data transmitted using a security provider by reducing an amount of data transmitted over a network in association with modeling security concepts in a sharable catalog. For instance, the techniques can improve network efficiency (e.g., save network bandwidth, free up memory and/or processor resources, etc.) by proactively providing a catalog of descriptions for visual data to devices free of receiving a request from a device and/or requiring the device to manually determine security concepts. Devices can receive a catalog proactively to enable each respective device to interpret application data, log data, image data, text data, and the like.

The techniques described herein can improve functioning of a computing device by providing a scalable and efficient method for predicting descriptions for input data having a different types of input data. For example, the computing device can determine security concepts over time resulting in a catalog covering security concept requests from a device (based on a similar concept being processed previously) thereby saving computational resources (e.g., a memory, a processor, and the like) that would otherwise be used to process similar security concepts for different host devices (e.g., customers, organizations, etc.). The system can transmit the catalog to the devices to reduce an amount of time and resources used to generate accurate semantic information, context, etc. (versus involving a user or individual requests from devices when not implementing the system).

Although in some examples the system comprises a computing device and a host device, in other examples, the system may enable the techniques described herein to be performed by the host device independent of the computing device and/or independent of a network connection. That is, either the host device and/or the computing device may implement one or more components and/or models to generate descriptions usable to prevent an anomaly impacting operation of a computing device such as to prevent a possible malicious event in the future.

In various instances, a computing device may install, and subsequently execute a security agent as part of a security service system to monitor and record events and/or patterns on a plurality of computing devices in an effort to detect, prevent, and mitigate damage from malware or malicious activity. In various examples, the security agent may detect, record, and/or analyze events on the computing device, and the security agent can send those recorded events (or data associated with the events) to a security system implemented in the “Cloud” (the “security system” also being referred to herein as a “security service system,” a “remote security service,” or a “security service cloud”). At the security system, the received events data can be further analyzed for purposes of detecting, preventing, and/or defeating malware and attacks. The security agent can, for instance, reside on the host device, observe and analyze events that occur on the host device, and interacts with a security system to enable a detection loop that is aimed at defeating all aspects of a possible attack.

Some examples herein relate to defining portions of data to detect malware or malicious behavior by, for example, implementing a large language model to provide suggested descriptions to a semantic data model. For brevity and ease of understanding, as used herein, “suspicious” refers to events or behavior determined using techniques described herein as being possibly indicative of attacks or malicious activity. The term “suspicious” does not imply or require that any moral, ethical, or legal judgment be brought to bear in determining suspicious events.

As used herein, the terms “threat actors” and “adversaries” include, e.g., malware developers, exploit developers, builders and operators of an attack infrastructure, those conducting target reconnaissance, those executing the operation, those performing data exfiltration, and/or those maintaining persistence in the network, etc. Thus the “adversaries” can include numerous people that are all part of an “adversary” group.

Some examples relate to receiving or processing a data string, byte slice, byte array, event stream, data sequence, or the like, indicating activities of system components such as processes or threads. Many system components, including malicious system components, perform a particular group of operations repeatedly. For example, a file-copy program repeatedly reads data from a source and writes data to a destination. In another example, a ransomware program repeatedly encrypts a file and deletes the un-encrypted original. Some examples relate to detecting such repetitions. Some examples locate repeated groups of operations based on detected events based on the field descriptions, permitting malware detection without requiring disassembly or other inspection of the code for that malware. Of course, the techniques can also be used to detect single, non-repetitive, instances that may occur in input data.

The techniques described herein may be implemented in a number of ways. Example implementations are provided below with reference to the following figures. Although discussed in the context of a security system in various examples, the methods, apparatuses, techniques, and systems, described herein can be applied to a variety of systems (e.g., data storage systems, service hosting systems, cloud systems, and the like), and are not limited to security systems. For example, an m-LLM can be trained to detect or otherwise output descriptions for an error, a malfunction, an excessive load, a system failure, an unexpected input, a configuration, setting, or parameter impacting performance of a computing device (e.g., a misconfiguration), hardware failures (e.g., a memory or processor having reduced or limited functionality), etc. That is, the m-LLM can be trained with a variety of training data to provide descriptions for problems typically encountered in the software industry, for example. For example, the system can implement a training component to receive labeled image data describing various types of anomalies, security threats, etc. to improve predictions associated with analyzing subsequent image data.

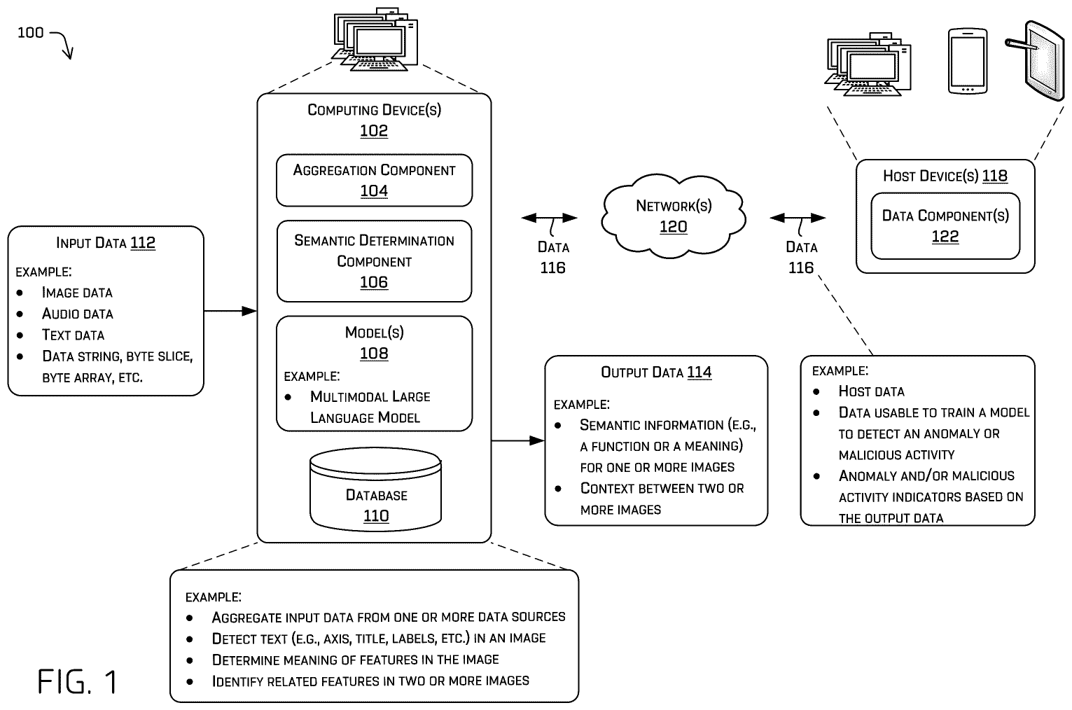

FIG. 1 illustrates an example block diagram 100 of an example computer architecture for determining semantic information for example input data, as described herein. The diagram 100 includes one or more computing device(s) 102 associated with a service system such as a security provider. In various examples, the service system may be part of, or associated with, a cloud-based service network that is configured to implement aspects of the functionality described herein.

FIG. 1 depicts the computing device(s) 102 comprising an aggregation component 104, a semantic determination component 106, one or more models 108, and a database 110 to perform the functionality described herein. For instance, the computing device(s) 102 can implement one or more components and/or one or more models to receive input data 112 such as a data string, byte array, byte slice, etc. and determine output data 114 indicating semantic information describing some or all of the input data 112 (e.g., a description of a graph or portion thereof).

In various examples, the computing device(s) 102 can exchange data 116 with one or more host device(s) 118 over one or more network(s) 120. The data 116 can represent one or more data strings (or other data structure) associated with the host device(s) 118 though the data 116 can come from a variety of data sources (e.g., data provided by the host device can include third-party data which may not follow a same data format, field naming schema, protocol, etc. as the host device). In some examples, the data 116 can represent a request to determine a security concept (e.g., a query about a security service) and/or a request to analyze application data, a dashboard, or other type of input data. For instance, the host device(s) 118 can transmit a message (as part of the data 116) requesting analysis of input data such as telemetry data, replicated data, stored data, metric data, etc. The computing device(s) 102 can, for example, generate the output data 114 describing a function, a meaning, a context, and/or presence of a security threat in the input data 112 based on the host device(s) 118 providing the input data 112 (or an identifier, a link, or the like usable for the computing device(s) 102 to access the data associated with the host device(s)). However, in other examples, the computing device(s) 102 can perform the techniques described herein independent of receiving a request from the host device(s) 118.

In various examples, the aggregation component 104 can provide functionality to aggregate, identify, retrieve, access, or otherwise determine the input data 112. The input data 112 can be associated with a data string(s), a data sequence(s), a byte slice, a byte array, or the like. The aggregation component 104 can, for example, retrieve data from a data stream, a database, a host device, a memory, and/or a storage device associated with the service system.

The semantic determination component 106 represents functionality to generate semantic data associated with the input data 112. The semantic data can, for example, include information describing a meaning of an image, text, and/or audio in the input data 112. In various examples, the semantic data can represent one or more of: semantic information, classifications (e.g., is an anomaly or malicious activity included in the image of the input data 112? “yes” or “no”, etc.), and the like.

In some examples, the semantic determination component 106 can implement or otherwise represent a multimodal large language model configured to receive some or all of the input data 112 and determine the semantic data. At least a portion of the output by the multimodal large language model can be used as the output data 114 while in other examples the output by the multimodal large language model can be sent to another model or component (e.g., the semantic determination component 106) for determining the output data 114.

In various examples, the semantic determination component 106 can detect text data (e.g., axis, title, labels, etc.) in an image, determine a meaning of one or more features in the image, and/or identify a first feature in a first image that is related to a second feature in a second image. For example, the semantic determination component 106 can receive, from the aggregation component 104, first text data and first image data representing first visual representations of a first set of metrics associated with the host device over a time period. The semantic determination component 106 can also receive, in some examples, second text data and second image data representing second visual representations of a second set of metrics associated with the host device over the time period. The first text or the second text can represent a word, a character, a symbol, a number, etc. associated with a respective graph, such as a graph of metrics captured over a time period. A metric in the first set or the second set of metrics can represent input information and/or output information associated with a data source such as one or more of: throughput, latency, a maximum output metric, a minimum output metric, an average output metric, an input rate, and output rate, a lag rate, a consumption rate, a first number of events associated with a first data source, or a second number of events associated with a second data source.

In various examples, the semantic determination component 106 can determine that a metric exceeds a metric threshold (e.g., the throughput or the latency exceeds a time threshold) and generate or otherwise determine the first image data or the second image data based at least in part on the throughput or the latency exceeding the time threshold. However, in other examples, the first image data and the second image data can be transmitted from the host device(s) 118 to the computing device(s) 102 as part of the data 116 at a first time.

In various examples, the semantic determination component 106 can determine a context or relationship between a first feature in the first image data and a second feature in the second image data. For example, the semantic determination component 106 can detect features such as a metric in a set of metrics that is above a threshold value, in a graph. The semantic determination component 106 can determine that the first metric exceeds a first metric threshold for a time period, determine that the second metric exceeds a second metric threshold for the time period, and output a value indicating that the first metric of the first image data is related to the second metric of the second image data.

In some examples, the semantic determination component 106 can determine receive first computer-readable instructions associated with a first operating system or first data format from a first data source, and receive second computer-readable instructions associated with a second operating system or second data format from a second data source. The semantic determination component 106 can determine the context or the semantic information independent of requiring input from a user (e.g., a user of the host device(s) 118).

The semantic determination component 106 can, in some examples, determine a number of events sent to an event queue over a time period, determine that the number of events exceeds an event threshold, and determine the context between the first metric and the second metric based at least in part on the number of events exceeding the event threshold.

In some examples, the semantic determination component 106 can determine the context based at least in part on detecting the text in the input data 112. For instance, a meaning of the first text relative to the first image data and another meaning of the second text relative to the second image data can be determined.

As described herein, the model(s) 108 may be representative of machine learned models, statistical models, heuristic models, or a combination thereof. For instance, the computing device(s) can implement the model(s) 108 as a machine learning model (e.g., a multimodal large language model, etc.), a semantic data model, just to name a few. The multimodal large language model can, for instance, be trained to improve accuracy of a description (e.g., a prediction) over time by receiving training data describing various images, etc.

The database 110 can represent a storage device for storing semantic descriptions, context, image data, security concepts, etc. to perform the techniques described herein. In some examples, the semantic determination component 106 can store data values representing a catalog of field descriptions and associated security concepts. For example, a catalog entry can include values representing a description for respective graphs in the input data 112.

In some examples, the data 116 can include catalog data for exchanging between the computing device(s) 102 and the host device(s) 118. The computing device(s) 102 can, in various examples, transmit some or all of the output data 114 to the host device(s) 118 as the data 116. In various examples, the output data 114 can be validated by the host device(s) 118 (e.g., by a component or user thereof). For example, a description (or other output data) from the multimodal large language model and/or the semantic determination component can be sent to the host device(s) 118 for validating the description (e.g., yes, no) or updating the description.

In some examples, a user (e.g., a developer, analyst, etc.) and/or a model associated with the host device(s) 118 can provide input to the semantic determination component 106 to verify accuracy of the output data 114 and/or to update the output data 114 prior to being included in a sharable catalog. For instance, the user can suggest that a different description be included in the catalog for output to other devices.

In some examples, the computing device(s) 102 can transmit output data 114 to the host device(s) 118 and cause the host device(s) 118 to detect and mitigate an anomaly (e.g., determine presence of the malicious event) based at least in part on transmitting the output data 114. In various examples, the computing device(s) 102 can store some or all of the output data 114 as stored data in the database 110 for access by the host device(s) 118 at a later time.

In some instances, a training component (not shown) may be executed by one or more processor(s) of a computing device to train a machine learning model based on training data. The training data may include a wide variety of data, such as labeled image data, labels describing a cause for an anomaly in an image, image names, image types, or a combination thereof, that is associated with a value (e.g., a classification of interest, inference, prediction, etc.). Such values may generally be referred to as a “ground truth.” To illustrate, the training data may be used for determining semantic data for portions of an image, a data string, a byte slice, a byte array, or the like. The semantic data may be associated with one or more classifications or determinations. In some examples, such a classification may be based on user input (e.g., user input indicating that the data depicts a specific field) or may be based on the output of another machine learned model. In some examples, such labeled classifications (or more generally, the labeled output associated with training data) may be referred to as ground truth.

The host device(s) 118 may implement one or more data components 122 which is stored in memory of the host device(s) 118 and executable by one or more processors of the host device(s) 118. The host device(s) 118 may be or include any suitable type of device, including, without limitation, a mainframe, a work station, a personal computer (PC), a laptop computer, a tablet computer, a personal digital assistant (PDA), a cellular phone, a media center, an embedded system, a robotic device, a wearable device (e.g., sunglasses, clothing, etc.), a vehicle, a Machine to Machine device (M2M), an unmanned aerial vehicle (UAV), an Internet of Things (IoT), or any other type of device or devices capable of communicating via an instance of the data component(s) 122. An entity may be associated with the host device(s) 118, and the entity (user, computing device, organization, or the like) may have registered for security services provided by a service provider of the computing device(s) 102.

In some embodiments, the network(s) 120 may include any one or more networks, such as wired networks, wireless networks, and combinations of wired and wireless networks. Further, the network(s) 120 may include any one or combination of multiple different types of public or private networks (e.g., cable networks, the Internet, wireless networks, etc.). In some instances, the host device(s) 118 and the computing device(s) 102 communicate over the network(s) 120 using a secure protocol (e.g., https) and/or any other protocol or set of protocols, such as the transmission control protocol/Internet protocol (TCP/IP).

The data component(s) 122 can represent software, firmware, hardware, or a combination thereof, that is configured to exchange data with the computing device(s) 102, and the components thereof. In some examples, the data component(s) 122 can be configured to send or receive data associated with a security concept to and/or from the computing device(s) 102. The data component(s) 122 may provide functionality for the host device 118 to interface with the computing device(s) 102 to manage a security concept, request security recommendations, and/or receive field description data as described herein.

The data component(s) 122 may, in some examples, be kernel-level security agents, or similar security application or interface to implement at least some of the techniques described herein. Such kernel-level security agents may each include activity pattern consumers that receive notifications of events in a query that meet query criteria. The kernel-level security agents may each be installed by and configurable by computing device(s) 102, receiving, and applying while live, reconfigurations of agent module(s) and/or an agent situational model. Further, the kernel-level security agents may each output query results to the computing device(s) 102 that include the security-relevant information determined by the data component(s) 122. The data component(s) 122 may continue to execute on the host device(s) 118 by observing and sending detected activity to the computing device(s) 102 while the host device(s) 118 is powered on and running.

In some embodiments, the data component(s) 122 may be connected to the computing device(s) 102 via a secure channel, such as a virtual private network (VPN) tunnel or other sort of secure channel and may provide query results security-relevant information to the computing device(s) 102 through the secure channel. The data component(s) 122 may also receive configuration updates, instructions, remediation, etc. from the computing device(s) 102 via the secure channel.

Though depicted in FIG. 1 as separate components of the computing device(s) 102, functionality associated with the aggregation component 104, the semantic determination component 106, and/or the model(s) 108 can be included in a different component of the service system, a single component, or be included in the host device(s) 118. Though FIG. 1 is described in relation to the host device(s) 118, the techniques can also or instead be used by other devices such as a third-party device that can become a customer of the security service provided to the host device(s) 118.

In some instances, the components described herein may comprise a pluggable component, such as a virtual machine, a container, a serverless function, etc., that is capable of being implemented in a service provider and/or in conjunction with any Application Program Interface (API) gateway.

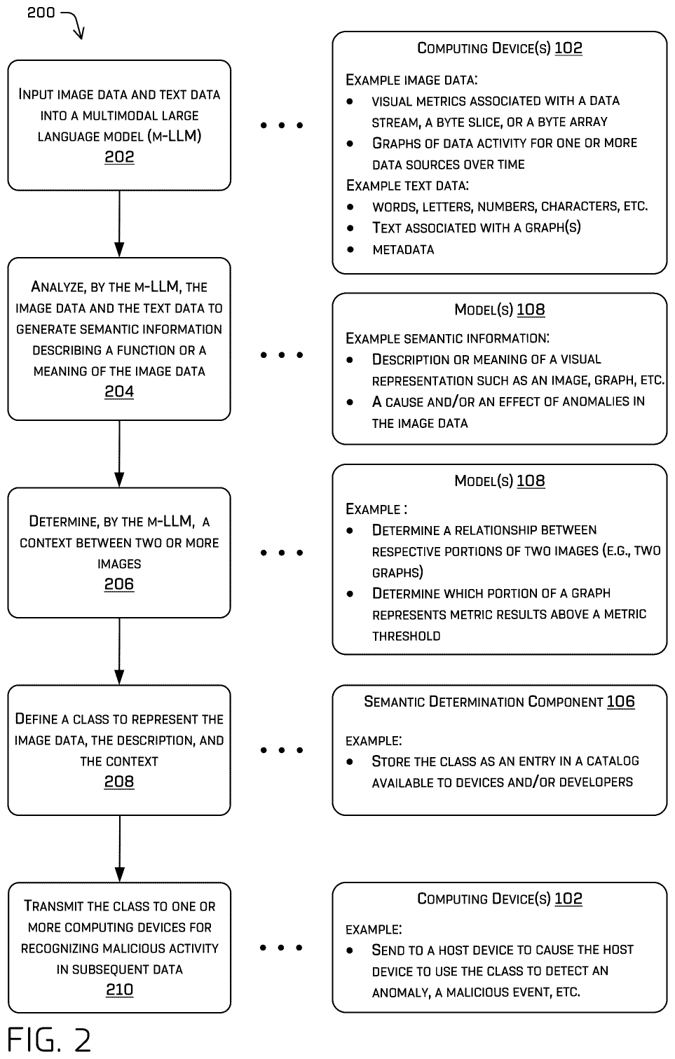

FIG. 2 is a pictorial diagram illustrating an example process 200 to determine descriptions for example image data by an example computing device, as described herein. The example process 200 may be implemented by a computing device such as the computing device(s) 102 of FIG. 1. The computing device(s) 102 can implement the aggregation component 104, the semantic determination component 106, and/or the model(s) 108 to generate semantic information for multimodal input data. The semantic information can be transmitted to a variety of computing devices (e.g., the host device(s) 118) to cause the computing device(s) to improve security by detecting subsequent visual data that is related to the semantic information. In some examples, the input data can represent a dynamic data stream (e.g., a data stream that changes over time) comprising data strings from multiple data sources.

An operation 202 can include inputting image data and text data into a multimodal large language model (m-LLM). For instance, the aggregation component 104 can retrieve, as input data, image data representing one or more graphs and text data representing text associated with the one or more graphs. The semantic determination component 106 can implement a multimodal large language model (e.g., as the model(s) 108) that receives the image data and the text data as input data.

The image data input into the m-LLM can represent visual metrics associated with a data stream, a byte slice, or a byte array. For examples, metrics indicative of data activity over time can be stored in a dashboard, graph, or other image to convey metric results for a time period. In some examples, the image data can be accessed by an identifier sent to the computing device(s) 102 such as a uniform resource locator (URL) to a website accessible over the Internet. The image data can, in some examples, represent a first graph and a second graph having respective sets of metrics associated with data activity of one or more data sources.

The text data input into the m-LLM can represent, for example, one or more of: a word, a letter, a number, a character, a symbol, or the like. The text data can represent an axis, a label, or a description of the graph(s) of the image data. In some examples, the text data can represent metadata associated with the image data and/or the text data.

In various examples, the input data can include or otherwise represent data associated with a third-party computing device, application, and so on. For example, the aggregation component 104 can aggregate the image data and the text data from a third-party application that requests security analysis of the input data.

An operation 204 can include analyzing, by the m-LLM, the image data and the text data to generate semantic information describing a function or a meaning of the image data. For example, the operation 204 can include the computing device(s) 102 implementing the model(s) 108 to output the function or the meaning of an image, a graph, or other type of visual representation. In some examples, the operation 204 can include comparing a metric of the first image data (e.g., an output rate for a data source) to a metric threshold and determining a cause or an effect of the metric exceeding the metric threshold, for example. In some examples, the model(s) 108 can compare the metric of the first image data to another metric of the second image data (e.g., latency for the data source over the same time period).

An operation 206 can include determining, by the m-LLM, a context between two or more images. For example, the operation 206 can include the model(s) 108 determine a relationship between respective portions of two images (e.g., two graphs) in the input data 112 and/or determining which portion of a respective image represents metric results above a metric threshold. The relationship between respective portions of the images can be based at least in part on a mathematical relationship between metrics of the respective portions. The relationship can vary, for example, based on whether a first metric(s) for a first image portion is proportional, inversely proportional, a derivative, an integral, or a time-delayed version of a second metric(s) for a second image portion, just to name a few. For example, the first image portion and the second image portion can each display a same anomaly or separate and dissimilar anomalies. Further, the model(s) 108 can determine that the first image portion and the second image portion are related based on respective metrics associated with a same time and/or an adjacent time.

An operation 208 can include defining a class to represent the image data, the description, and the context. For instance, the operation 208 can include the semantic determination component 106 determining a class (e.g., a set of values, etc.) to associate the description for respective images as an entry in a catalog of classes. In some examples, the semantic determination component 106 can cause the class to be stored in a storage device (e.g., the database 110) and/or transmitted to various computing devices prior to receiving a request from at least one of the computing devices.

An operation 210 can include transmitting the class to one or more computing devices for recognizing one or more anomalies in subsequent data. In some examples, data associated with the class can be sent to a host device to cause the host device to detect and analyze fields from a data stream, or other data source with a data string for analysis. In some examples, data describing a variety of images and security concepts can be transmitted to the one or more computing devices to enable detection of an anomaly, malicious activity (e.g., to monitor a data stream having subsequent image data corresponding to a defined class in the catalog), and the like.

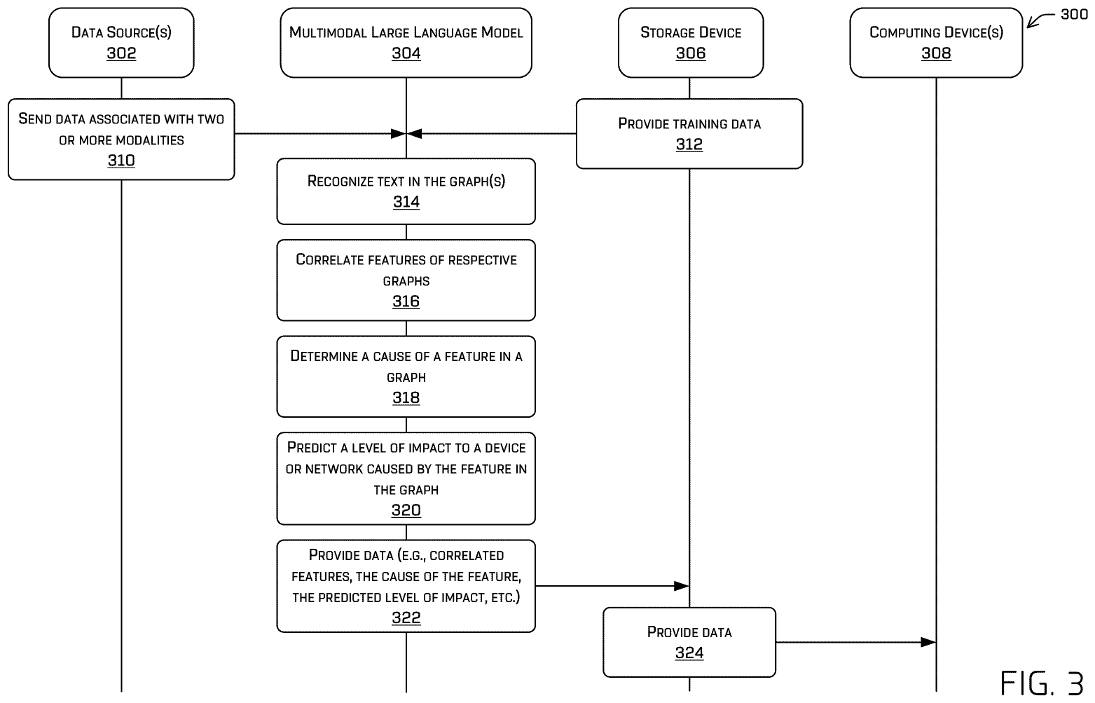

FIG. 3 is a pictorial diagram illustrating another example process 300 for determining descriptions for example graphs and optionally providing the descriptions to a storage device and/or a computing device, as described herein. The example process 300 may be implemented by a computing device such as the computing device(s) 102 of FIG. 1. The computing device(s) 102 can implement the aggregation component 104, the semantic determination component 106, and/or the model(s) 108 to generate the output data 114 for sending to a computing device (e.g., the host device(s) 118). FIG. 3 further depicts one or more data sources 302 (also referred to as “the data source 302” or “the data sources 302”), a multimodal large language model (m-LLM) 304, a storage device 306, and one or more computing device(s) 308.

The data source(s) 302 can represent a host device, a third party device, a storage device such as the database 110 of FIG. 1, just to name a few. The m-LLM 304 can represent functionality associated with the model(s) 108 of FIG. 1. The storage device 306 can represent, for example, a registry, a database, a memory, or the like, and can include the functionality associated with the database 110 of FIG. 1.

The computing device(s) 308 can, in various examples, represent a host device, a third-party device, and/or a device associated with a service provider (e.g., a device associated with a developer of a security service).

An operation 310 can include the data source(s) 302 sending data associated with two or more modalities to the m-LLM 304. For example, the data source(s) 302 can transmit data associated with a data stream to the m-LLM 304 for processing.

An operation 312 can include the storage device 306 providing training data to the m-LLM 304. To train the m-LLM 304, the storage device 306 can provide training data representing labeled visual data, class information, or the like to improve accuracy or an output by the m-LLM over time.

An operation 314 can include the m-LLM 304 recognizing text in the graph(s). The m-LLM 304 can, for instance, detect text in image data such as words, letters, symbols, etc. included in an image, a graph, or other visual representation.

An operation 316 can include the m-LLM 304 correlating features of respective graphs. For example, the m-LLM 304 can detect features such as a metric that is above a metric threshold, an anomaly in a graph, and determine whether a first feature (e.g., an output rate exceeding an output threshold) of a first graph is related to a second feature (e.g., latency exceeding a latency threshold) of a second graph. In various examples, the m-LLM 304 can classify two features as correlated or related based at least in part on each feature exceeding a respective threshold and occurring within a threshold time of one another.

Features of an image can, for example, include axes, labels, units or similar conventions (events per second, operations per watt, etc.), markers signifying events or limits, visual indicators such as lines or bars for metrics, a ‘key’ (e.g., for identifying a metric), charts, histograms, meter-type displays, titles such as a global title, etc. Features of the image can also or instead include visual indicators of a selector(s) and/or time interval(s) representing another image, graph, dashboard, etc.

In some examples, the operation 316 can be performed periodically (e.g., at a pre-determined interval) and/or responsive to the host device(s) 118 sending the data as part of operation 310.

An operation 318 can include the m-LLM 304 determining a cause of a feature in a graph (e.g., a reason for the feature in the graph). For example, the m-LLM 304 can apply one or more algorithms to the data received in association with operation 310, the data associated with operation 314, and/or the correlated features of respective graphs associated with operation 316. In some examples, the operation 318 can receive, as input data, data from another operation, such as operation 320 (e.g., a level of impact to a device or network). Determining the cause of the feature in the graph can, for example, include the m-LLM 304 analyzing one or more graphs, determining relevant data associated with the graph(s), aggregating additional data via one or more interfaces from one or more sources (e.g., accessing data exchanged before and/or after the feature), and outputting a description of an origination or cause for the feature in the graph.

An operation 320 can include the m-LLM 304 predicting a level of impact to a device or network caused by the feature in the graph. For example, the feature can represent latency associated with a data source, and the m-LLM 304 can determine the level of impact to operation of the data source 302. In some examples, the m-LLM 304 can initiate a query or otherwise access network data, metrics, or other data associated with the device or the network element for determining the level of operation by a memory resource, processor resource before presence of the feature, for example.

An operation 322 can include m-LLM 304 providing the data to the storage device 306. For instance, the m-LLM 304 can transmit one or more of: correlated features, the cause of one or more features, the predicted level of impact of a respective feature, etc. to the storage device 306. In some examples, the storage device 306 can be configured or provide functionality of the database 110.

An operation 324 can include the storage device 306 providing stored data to the computing device(s) 308. For instance, the computing device(s) 102 can transmit at least some of the data from the storage device 306 to the computing device(s) 308. In some examples, a catalog of data can be provided to the computing device(s) 308 (or a user thereof).

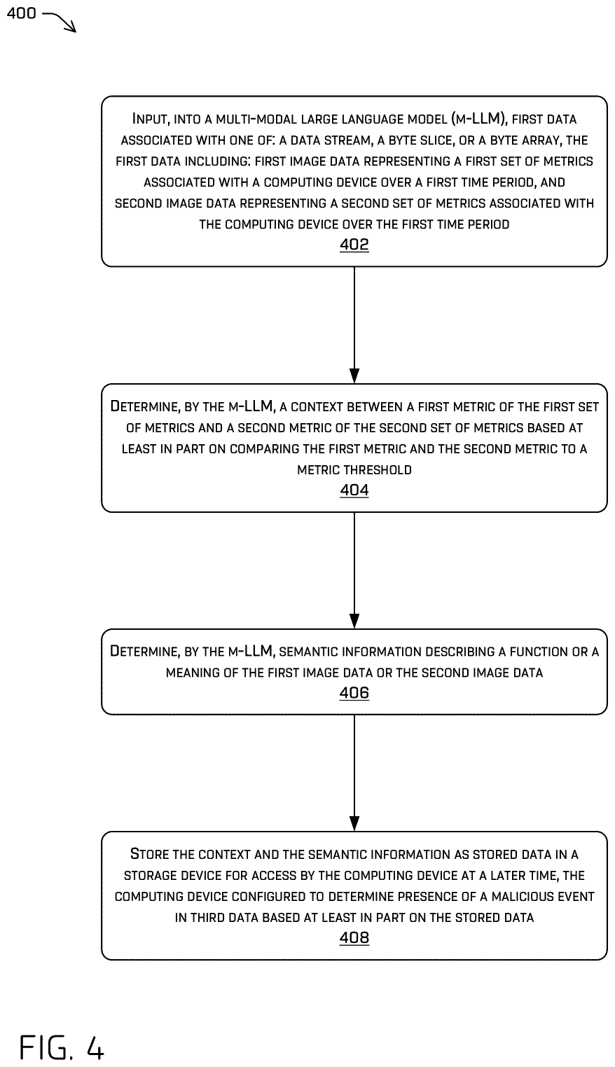

FIG. 4 is a flowchart depicting an example process 400 for determining semantic information and/or a context for image data. Some or all of the process 400 may be performed by one or more components in FIG. 1 as described herein. For example, some or all of process 400 may be performed by the computing device(s) 102 (or service associated therewith). In various examples, the computing device(s) 102 can implement the model(s) 108 or the m-LLM 304 to determine a context and/or a semantic information of multimodal input data independent of requiring input from a user.

At operation 402, the process can include inputting, into a multi-modal large language model (m-LLM), first data associated with one of: a data stream, a byte slice, or a byte array, the first data including: first image data representing a first set of metrics associated with a computing device over a first time period, and second image data representing a second set of metrics associated with the computing device over the first time period. In some examples, the operation 402 can include the computing device(s) 102 receiving a first image representing a first graph of one or more metrics and a second image representing a second graph of one or more metrics different from those of the first graph. In various examples, the first data and the second data can represent different event data occurring at a host device over a time period.

In various examples, the first data or the second data can include detection data associated with previous activity in a data stream of a host device (e.g., a potentially malicious process or thread, an instruction to write data to a memory, file, or the like). The detection data can, for example, include data strings, byte arrays, or another data structure for analysis. The computing device(s) 102 can, for example, receive the detection data associated with the host device in real-time. In some examples, the computing device(s) 102 can receive data from a storage device (e.g., the database 110) as part of the input data. Though described in relation to an m-LLM in the present example, other model types including different machine learned models may also or instead be used to implement the techniques described herein.

In various examples, the first data can represent first computer-readable instructions associated with a first operating system or first data format and the second data can represent second computer-readable instructions associated with a second operating system or second data format. In this way, the m-LLM can process computer-readable instructions regardless of a type of operating system or data format used by a device to send data for processing.

At operation 404, the process can include determining, by the m-LLM, a context between a first metric of the first set of metrics and a second metric of the second set of metrics based at least in part on comparing the first metric and the second metric to a metric threshold. For example, the computing device(s) 102 can implement the model(s) 108 to compare metrics included in first graph with metrics included in the second graph, and based on the comparison, output a value indicating whether the metrics are “related”. In some examples, the computing device(s) 102 can determine a number of events sent to an event queue over a time period (e.g., data transactions by the host device) and determine whether the number of events exceeds an event threshold. In examples when the number of events exceeding the event threshold, the computing device(s) 102 can output an indication that the first metric and the second metric have a same cause or a same effect.

At operation 406, the process can include determining, by the m-LLM, semantic information describing a function or a meaning of the first image data or the second image data. For instance, the computing device(s) 102 can output second data representing a description for at least the first field of the first data (e.g., a data field of a data string) based on data received from the storage device.

At operation 408, the process can include storing the context and the semantic information as stored data in a storage device for access by the computing device at a later time, the computing device configured to determine presence of a malicious event in third data based at least in part on the stored data. For instance, the computing device(s) 102 can implement the semantic determination component 106 to store the output data from the m-LLM 304 in the storage device 306. In some examples, the data can be available to various computing devices proactively (e.g., as catalog data) by transmitting some or all of the context, semantic information, etc. to a computing device.

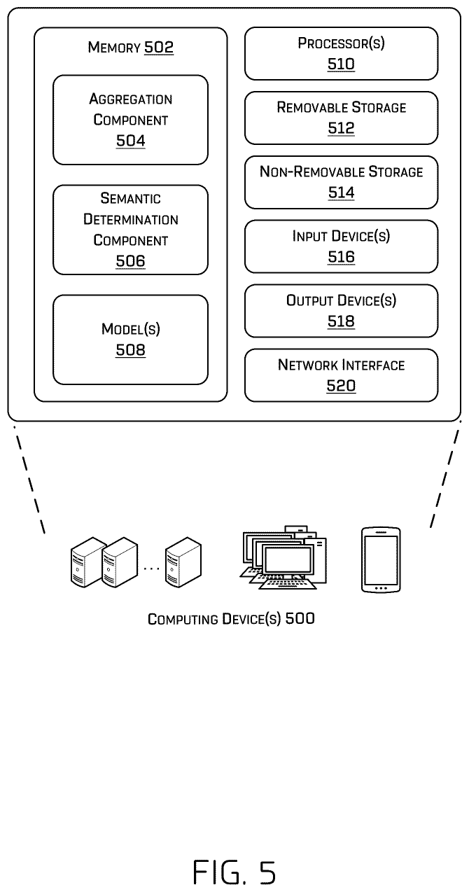

FIG. 5 is a block diagram of an illustrative computing architecture of the computing device(s) 500 to implement the techniques describe herein. In some embodiments, the computing device(s) 500 can correspond to the host device(s) 118 or the computing device(s) 102 of FIG. 1. It is to be understood in the context of this disclosure that the computing device(s) 500 can be implemented as a single device or as a plurality of devices with components and data distributed among them. By way of example, and without limitation, the computing device(s) 500 can be implemented as various computing device 500(1), 500(2), . . . , 500(N) where N is an integer greater than 1.

As illustrated, the computing device(s) 500 comprises a memory 502 storing an aggregation component 504, a semantic determination component 506, and model(s) 508. Also, the computing device(s) 500 includes processor(s) 510, a removable storage 512 and non-removable storage 514, input device(s) 516, output device(s) 518, and network interface 520.

In various embodiments, memory 502 is volatile (such as RAM), non-volatile (such as ROM, flash memory, etc.) or some combination of the two. The aggregation component 504, the semantic determination component 506, and the model(s) 508 stored in the memory 502 can comprise methods, threads, processes, applications or any other sort of executable instructions. The aggregation component 504, the semantic determination component 506, and the model(s) 508 can also include files and databases.

In various embodiments, the memory 502 generally includes both volatile memory and non-volatile memory (e.g., RAM, ROM, EEPROM, Flash Memory, miniature hard drive, memory card, optical storage, magnetic cassettes, magnetic tape, magnetic disk storage or other magnetic storage devices, or any other medium). The memory 502 may also be described as computer storage media or non-transitory computer-readable media, and may include volatile and nonvolatile, removable and non-removable media implemented in any method or technology for storage of information, such as computer readable instructions, data structures, program modules, or other data. Computer-readable storage media (or non-transitory computer-readable media) include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, and the like, which can be used to store the identified information and which can be accessed by the security service system. Any such memory 502 may be part of the security service system.

The aggregation component 504 may receive and store any client entity information and their associated security information including observed activity patterns received from the data component(s) 122 on the respective host device(s) 118. The aggregation component 504 may gather data from other modules that may be stored in a data store. In some embodiments, the aggregation component 504 may gather and store data associated with known information, such as domain information that is associated with known entities, for access as input data by the semantic determination component 506 (or other component).

In some examples, the aggregation component 504 can correspond to, or otherwise include the functionality of, the aggregation component 104 of FIG. 1.

In some instances, the semantic determination component 506 can correspond to, or otherwise include the functionality of, the semantic determination component 106 of FIG. 1.

In some instances, the model(s) 508 can correspond to, or otherwise include the functionality of, the model(s) 108 of FIG. 1.

In some instances, any or all of the devices and/or components of the computing device(s) 500 may have features or functionality in addition to those that FIG. 5 illustrates. For example, some or all of the functionality described as residing within any or all of the computing device(s) 500 may reside remotely from that/those computing device(s) 500, in some implementations.

The computing device(s) 500 may be configured to communicate over a telecommunications network using any common wireless and/or wired network access technology. Moreover, the computing device(s) 500 may be configured to run any compatible device operating system (OS), including but not limited to, Microsoft Windows Mobile, Google Android, Apple iOS, Linux Mobile, as well as any other common mobile device OS.

The computing device(s) 500 also can include input device(s) 516, such as a keypad, a cursor control, a touch-sensitive display, voice input device, etc., and output device(s) 518 such as a display, speakers, printers, etc. These devices are well known in the art and need not be discussed at length here.

As illustrated in FIG. 5, the computing device(s) 500 also includes the network interface 520 that enables the computing device(s) 500 of the security service system to communicate with other computing devices, such as any or all of the host device(s) 118.

FIGS. 2-4 illustrate example processes in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes. For instance, the example process of FIG. 2 may omit operations 210 and the example process of FIG. 3 may omit operations 316, 318, and/or 320. In some examples, the example process of FIG. 4 may omit operation 408.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. For instance, the process 200 may omit the operation 210 and/or the process 300 can omit the operations 312 and/or 322. Moreover, the methods described herein can be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed processes could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the one or more processors to perform operations comprising:
receiving, by multimodal large language model (m-LLM), first data representing first text and first image data, the first image data including first visual representations of a first set of metrics associated with a computing device over a time period;
receiving, by the m-LLM, second data representing second text and second image data, the second image data including second visual representations of a second set of metrics associated with the computing device over the time period;
comparing the first visual representations of the first image data and the second visual representations of the second image data;
determining, by the m-LLM, a context between a first metric of the first set of metrics and a second metric of the second set of metrics based at least in part on the comparing, the first text, and the second text;
determining, by the m-LLM, semantic information describing a function or a meaning of the first visual representations or the second visual representations; and
storing the context and the semantic information as stored data in a storage device for access by a computing device at a later time, the computing device configured to determine presence of a malicious event in third data based at least in part on the stored data.

2. The system of claim 1, wherein determining the context between the first metric of the first set of metrics and a second metric of the second set of metrics comprises:
determining that the first metric exceeds a first metric threshold for a time period;
determining that the second metric exceeds a second metric threshold for the time period; and
outputting a value indicating that the first metric of the first image data is related to the second metric of the second image data.

3. The system of claim 1, wherein the first data is received from an event queue, and the operations further comprising:
determining a number of events sent to the event queue over a time period;
determining that the number of events exceeds an event threshold; and
determining the context between the first metric and the second metric based at least in part on the number of events exceeding the event threshold.

4. The system of claim 1, wherein:
the first data represents first computer-readable instructions associated with a first operating system or first data format,
the second data represents second computer-readable instructions associated with a second operating system or second data format, and
determining the context or the semantic information is performed independent of requiring input from a user.

5. The system of claim 1, wherein the first data is received from an event queue, and the operations further comprising:
determining throughput or latency for a data source associated with the first data;
determining that the throughput or the latency exceeds a time threshold; and
determining the first image data or the second image data based at least in part on the throughput or the latency exceeding the time threshold.

6. One or more non-transitory computer-readable media storing instructions executable by one or more processors, wherein the instructions, when executed, cause the one or more processors to perform operations comprising:
inputting, into a multimodal large language model (m-LLM), first data associated with one of: a data stream, a byte slice, or a byte array, the first data including:
first image data representing a first set of metrics associated with a computing device over a first time period, and
second image data representing a second set of metrics associated with the computing device over the first time period;
determining, by the m-LLM, a context between a first metric of the first set of metrics and a second metric of the second set of metrics based at least in part on comparing the first metric and the second metric to a metric threshold;
determining, by the m-LLM, semantic information describing a function or a meaning of the first image data or the second image data; and
storing the context and the semantic information as stored data in a storage device for access by the computing device at a later time, the computing device configured to determine presence of a malicious event in third data based at least in part on the stored data.

7. The one or more non-transitory computer-readable media of claim 6, wherein:
the first image data represents a first graph,
the second image data represents a second graph,
and determining the context between the first metric of the first set of metrics and a second metric of the second set of metrics comprises:
determining that the first metric exceeds a first metric threshold for a time period;
determining that the second metric exceeds a second metric threshold for the time period; and
outputting a value indicating that the first metric of the first graph is related to the second metric of the second graph.

8. The one or more non-transitory computer-readable media of claim 6, wherein the first image data represents a first graph and the second image data represents a second graph, and the operations further comprising:
detecting text in one of: the first graph or the second graph, the text associated with an axis, a title, or a label of the first graph or the second graph,
wherein determining the context is further based at least in part on the text.

9. The one or more non-transitory computer-readable media of claim 6, the operations further comprising:
determining throughput or latency for a data source associated with the first data;
determining that the throughput or the latency exceeds a time threshold; and
determining the first image data or the second image data based at least in part on the throughput or the latency exceeding the time threshold.

10. The one or more non-transitory computer-readable media of claim 6, the operations further comprising:
transmitting the stored data to the computing device; and
causing the computing device to determine presence of the malicious event in the third data based at least in part on accessing the stored data from the storage device.

11. The one or more non-transitory computer-readable media of claim 6, wherein determining the context between the first metric of the first set of metrics and a second metric of the second set of metrics comprises:
determining that the first metric exceeds a first metric threshold for a time period;
determining that the second metric exceeds a second metric threshold for the time period; and
outputting a value indicating that the first metric of the first image data is related to the second metric of the second image data.

12. The one or more non-transitory computer-readable media of claim 6, wherein the first data is received from a data source, and the operations further comprise:
determining a number of events sent to the data source over a time period;
determining that the number of events exceeds an event threshold; and
determining the context between the first metric and the second metric based at least in part on the number of events exceeding the event threshold.

13. The one or more non-transitory computer-readable media of claim 6, wherein:
the first data represents first computer-readable instructions associated with a first operating system or first data format,
the second data represents second computer-readable instructions associated with a second operating system or second data format, and
determining the context or the semantic information is performed independent of requiring input from a user.

14. The one or more non-transitory computer-readable media of claim 6, the operations further comprising:
determining throughput or latency for a data source associated with the first data;
determining that the throughput or the latency exceeds a time threshold; and
determining the first image data or the second image data based at least in part on the throughput or the latency exceeding the time threshold.

15. The one or more non-transitory computer-readable media of claim 6, wherein the first set of metrics or the second set of metrics includes one or more of: a maximum output metric, a minimum output metric, an average output metric, an input rate, and output rate, a lag rate, a consumption rate, a first number of events associated with a first data source, or a second number of events associated with a second data source.

16. The one or more non-transitory computer-readable media of claim 6, wherein the first data is received from one of: an event-based message queue, a service, or a third-party queue.

17. A computer-implemented method comprising:
inputting, into a multimodal large language model (m-LLM), first data associated with one of: a data stream, a byte slice, or a byte array, the first data including:
first image data representing a first set of metrics associated with a computing device over a first time period, and
second image data representing a second set of metrics associated with the computing device over the first time period;
determining, by the m-LLM, a context between a first metric of the first set of metrics and a second metric of the second set of metrics based at least in part on comparing the first metric and the second metric to a metric threshold;
determining, by the m-LLM, semantic information describing a function or a meaning of the first image data or the second image data; and
storing the context and the semantic information as stored data in a storage device for access by the computing device at a later time, the computing device configured to determine presence of a malicious event in third data based at least in part on the stored data.

18. The computer-implemented method of claim 17, wherein:
the first image data represents a first graph,
the second image data represents a second graph,
and determining the context between the first metric of the first set of metrics and a second metric of the second set of metrics comprises:
determining that the first metric exceeds a first metric threshold for a time period;
determining that the second metric exceeds a second metric threshold for the time period; and
outputting a value indicating that the first metric of the first graph is related to the second metric of the second graph.

19. The computer-implemented method of claim 17, wherein the first image data represents a first graph, the second image data represents a second graph, and further comprising:
detecting text in one of: the first graph or the second graph, the text associated with an axis, a title, or a label of the first graph or the second graph,
wherein determining the context is further based at least in part on the text.

20. The computer-implemented method of claim 17, further comprising:
determining throughput or latency for a data source associated with the first data;
determining that the throughput or the latency exceeds a time threshold; and
determining the first image data or the second image data based at least in part on the throughput or the latency exceeding the time threshold.
